(19) United States
(12) Patent Application Publication
(10) Pub. No.: US 2024/0076465 A1
(43) Pub. Date: Mar. 7, 2024

(54) Foam and Solid Recycled Rubber Compositions and Methods for and Products Constructed From the Same

(71) Applicant: Vaibhav V. Meharwade, Dublin, OH (US)

(72) Inventor: Vaibhav V. Meharwade, Dublin, OH (US)

(21) Appl. No.: 18/450,574

(22) Filed: Aug. 16, 2023

Related U.S. Application Data
(60) Provisional application No. 63/374,454, filed on Sep. 2, 2022.

(51) Int. Cl. C08J 9/32; C08K 3/06; C08K 3/22; C08K 5/09; C08K 5/47; C08L 17/00

(52) U.S. Cl. CPC C08J 9/32; C08K 3/06; C08K 3/22; C08K 5/09; C08K 5/47; C08L 17/00; C08J 2203/22; C08J 2307/00; C08J 2309/02; C08J 2323/16; C08K 2003/2296; C08L 2207/20

(57) ABSTRACT

A foam rubber composition includes a base recycled vulcanized rubber; one or more foaming agents; and one or more processing aids, such as a curative, an accelerator, an activator, a fatty acid, a reodorant, a non-recycled elastomer, or combinations thereof. Products are constructed from the foam rubber composition for different applications. A solid rubber composition includes a base recycled vulcanized rubber and one or more processing aids, such as a curative, an accelerator, an activator, a fatty acid, a reodorant, a non-recycled elastomer, or combinations thereof. Products are constructed from the solid rubber composition for different applications.

### CROSS-REFERENCE TO RELATED APPLICATIONS

This application which claims priority to U.S. Provisional Patent App. No. 63/374,454, filed Sep. 2, 2022, the entire disclosure of which is hereby incorporated by reference as if set forth in its entirety herein.

### TECHNICAL FIELD

This disclosure generally relates to foam and solid rubber compositions including recycled rubber and methods for and products constructed from the same. More specifically, this disclosure relates to foam and solid rubber compositions including a base recycled vulcanized rubber and one or more processing aids.

### BACKGROUND

Until now, the dual advantage of sustainability and durability in recycled rubber products (e.g., shoe components) produced from the process of vulcanization has not been fully realized.

Virgin rubber products made from natural rubber, Styrene-butadiene rubber (SBR), nitrile, and/or other elastomers may undergo vulcanization processes which make them a thermoset polymer and not feasible for reusability or re-molding. End-of-life virgin rubber products (e.g., end-of-life tires) are commonly discarded in abundant quantities contributing to undesirable waste generation and/or recycling issues due to the fact that these polymers are generally not biodegradable.

There exists a growing need for producing products made from recycled materials to address concerns of dependability on petroleum-based products, waste management, and climate change. Moreover, it would be desirable to produce rubber compositions from which products can be constructed, with such compositions avoiding the use of virgin rubber products and/or polluting ingredients (e.g., carbon black) commonly used in rubber compounds. Further yet, it would be desirable to prevent the waste thermoset rubber from being unnecessarily discarded in landfills or oceans or being incinerated leading to environmental pollution.

The foam and solid rubber compositions described herein may provide for the re-use of waste rubber (up to 100%) in rubber compounding and molding processes to promote sustainability and to utilize superior material properties of recycled vulcanized rubber with natural rubber, SBR, EPDM, Neoprene, nitrile and/or other elastomers contents, such as high shock absorption, high abrasion resistance, high tensile strength, high percent elongation, and/or high durability for targeted applications, such as by utilizing waste thermoset or waste vulcanized rubber products that have undergone devulcanization or reclaiming or grinding processes, and re-formulate such recycled vulcanized rubber to form molded solid or foam rubber products via the process of re-vulcanization, renewed cross-linking, and/or vulcanization such that the products may be re-purposed and re-used for applications such as footwear, impact tools, wheels, marine fenders, or the like.

### SUMMARY

According to an aspect of this disclosure, a foam rubber composition is disclosed. The foam rubber composition includes a base recycled vulcanized rubber, one or more foaming agents, and one or more processing aids.

The base recycled vulcanized rubber may include devulcanized rubber, grounded rubber, reclaimed rubber, or combinations thereof.

The base recycled vulcanized rubber may be selected from the group consisting of end-of-life tires, waste ethylene propylene diene monomer (EPDM) rubber parts, end-of-life butyl rubber tubes, used nitrile gloves, used latex gloves, and waste thermoset rubber.

The one or more foaming agents may be powders. Such foaming agents may be selected from the group consisting of p-toluenesulfonyl semicarbazide (TSSC), 5-phenyl tetrazole (5-PT), dinitroso pentamethylene tetramine (DPT), carbon monoxide (CO), benzensulfonyl hydrazide (TSH), azodicarbonamide, unexpanded thermoplastic microspheres, and supercritical carbon dioxide.

The one or more processing aids may include a curative, an accelerator, an activator, a fatty acid, a reodorant, a non-recycled elastomer, or combinations thereof.

The foam rubber composition may include from 15 to 175 parts, per hundred of rubber (PHR), of the base recycled vulcanized rubber. The foam rubber composition may include from 3 to 10 parts, per hundred of rubber (PHR), of the one or more foaming agents. The foam rubber composition may include from 1 to 20 parts, per hundred of rubber (PHR), of the one or more processing aids.

The foam rubber composition may further include a non-recycled elastomer. The foam rubber composition may include from 5 to 95 parts, per hundred of rubber, of the non-recycled elastomer.

The foam rubber composition may further include a curative. The foam rubber composition may include from 0.5 to 5 parts, per hundred of rubber (PHR), of the curative. The curative may be selected from the group consisting of sulphur, peroxide, Phenolic resins, metal oxide based curatives, or combinations thereof.

The foam rubber composition may further include an accelerator. The foam rubber composition may include from 0.25 to 2.25 parts, per hundred of rubber, of the accelerator. The accelerator may be selected from the group consisting of N-tert-butyl-benzothiazole sulfonamide (TBBS), tetramethylthiuram disulfide (TMTD), and mercaptobenzothiazole (MBT).

The foam rubber composition may further include an activator. The foam rubber composition may include from 1 to 10 parts, per hundred of rubber (PHR), of the activator. The foam rubber composition may further include a fatty acid. The foam rubber composition may include from 0.25 to 10 parts, per hundred of rubber, of the fatty acid.

According to another aspect of this disclosure, a product is disclosed. The product is constructed from the foam rubber composition described herein. The product may be selected from the group consisting of a footwear insole, a footwear outsole, a footwear midsole, a splash block, and a seat cushion. The product may have a density of from about 100 to about 700 kg/m³. The product may have a shore A hardness of from about 10 to about 70.

According to a further aspect of this disclosure, method for producing the foam rubber composition described herein is disclosed. The method includes providing the base recycled vulcanized rubber and combining the base recycled vulcanized rubber with one or more foaming agents and one or more processing aids.

According to yet another aspect of this disclosure, a solid rubber composition is disclosed. The solid rubber composition includes a base recycled vulcanized rubber and one or more processing aids.

The one or more processing aids may include a curative, an accelerator, an activator, a fatty acid, a reodorant, a non-recycled elastomer, or combinations thereof.

The solid rubber composition may include from 15 to 175 parts, per hundred of rubber (PHR), of the base recycled vulcanized rubber. The solid rubber composition may include from 1 to 95 parts, per hundred of rubber (PHR), of the one or more processing aids.

According to another aspect of this disclosure, a product is disclosed. The product is constructed from the solid rubber composition described herein. The product may be selected from the group consisting of a footwear outsole, a footwear midsole, a mallet head, a caster wheel, a skateboard wheel, a door wedge, a toilet plunger head, and a marine fender.

According to a further aspect of this disclosure, a mallet is disclosed. The mallet includes a head. The head is constructed from the solid rubber composition described herein. The mallet further includes a handle. The handle is made from a recycled high-density polyethylene (HDPE).

### BRIEF DESCRIPTION OF THE DRAWINGS

The present application is further understood when read in conjunction with the appended drawings. For the purpose of illustrating the subject matter, there are shown in the drawings exemplary aspects of the subject matter; however, the presently disclosed subject matter is not limited to the specific methods, devices, and systems disclosed. In the drawings:

FIG. 1 schematically illustrates a foam rubber composition according to an aspect of this disclosure;

FIG. 2A depicts a footwear insole constructed from a foam rubber composition according to an aspect of this disclosure;

FIG. 2B depicts a footwear midsole constructed from a foam rubber composition according to an aspect of this disclosure;

FIG. 2C depicts a footwear outsole constructed from a foam rubber composition according to an aspect of this disclosure;

FIG. 2D depicts a splash block constructed from a foam rubber composition according to an aspect of this disclosure;

FIG. 2E depicts a seat cushion constructed from a foam rubber composition according to an aspect of this disclosure;

FIG. 3 schematically illustrates a solid rubber composition according to an aspect of this disclosure;

FIG. 4A depicts a footwear midsole constructed from a solid rubber composition according to an aspect of this disclosure;

FIG. 4B depicts a footwear outsole constructed from a solid rubber composition according to an aspect of this disclosure;

FIG. 4C depicts a door wedge constructed from a solid rubber composition according to an aspect of this disclosure;

FIG. 4D depicts a skateboard wheel constructed from a solid rubber composition according to an aspect of this disclosure;

FIG. 4E depicts a caster constructed from a solid rubber composition according to an aspect of this disclosure;

FIG. 4F depicts a toilet plunger head constructed from a solid rubber composition according to an aspect of this disclosure;

FIG. 4G depicts a marine fender constructed from a solid rubber composition according to an aspect of this disclosure; x

FIG. 4H depicts a mallet according to an aspect of this disclosure;

FIG. 5A depicts a rheology curve for a foam rubber composition having a formulaic breakdown according to an aspect of this disclosure;

FIG. 5B depicts a rheology curve for a foam rubber composition having a formulaic breakdown according to an aspect of this disclosure;

FIG. 5C depicts a rheology curve for a foam rubber composition having a formulaic breakdown according to an aspect of this disclosure;

FIG. 5D depicts a rheology curve for a solid rubber composition having a formulaic breakdown according to an aspect of this disclosure;

FIG. 5E depicts mixing data temperature for a solid rubber composition having a formulaic breakdown according to an aspect of this disclosure;

FIG. 5F depicts mixing data power for a solid rubber composition having a formulaic breakdown according to an aspect of this disclosure;

FIG. 5G depicts mixing data integrated power for a solid rubber composition having a formulaic breakdown according to an aspect of this disclosure; and

FIG. 5H depicts a rheology curve for a solid rubber composition having a formulaic breakdown according to an aspect of this disclosure.

Aspects of this disclosure will now be described in detail with reference to the drawings, wherein like reference numbers refer to like elements throughout, unless specified otherwise.

### DETAILED DESCRIPTION OF ILLUSTRATIVE EMBODIMENTS

Described herein are foam and solid rubber compositions and methods for and products constructed from the same. Certain terminology is used to describe the foam and solid rubber compositions in the following description for convenience only and is not limiting.

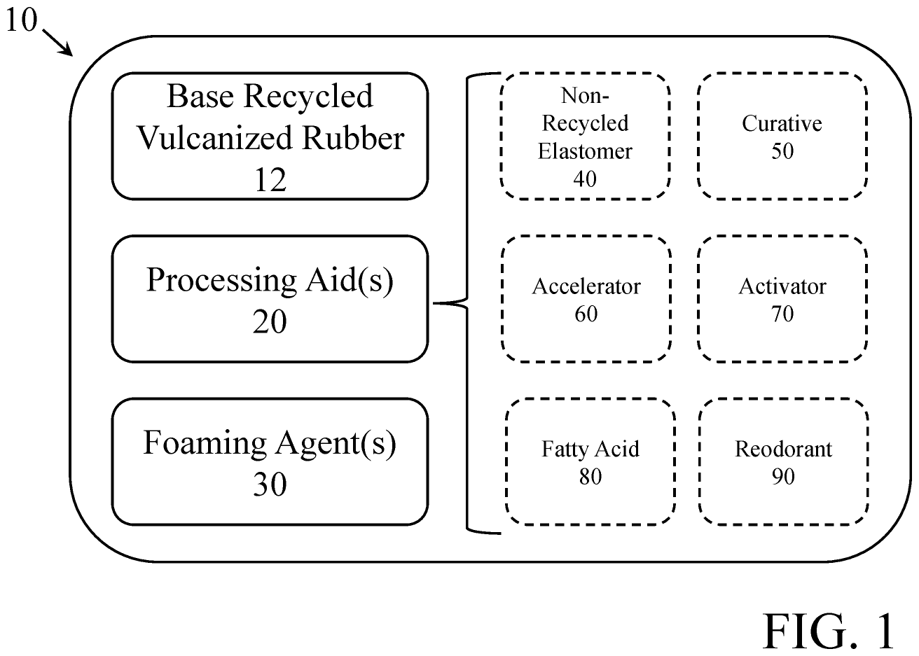

Referring to FIG. 1, features of a sponge or foam rubber composition 10 according to one aspect may be seen and will be described (hereinafter referred to as a “foam rubber composition” for brevity). The foam rubber composition 10 includes a base recycled vulcanized rubber 12, one or more processing aids 20, and one or more foaming agents 30.

The base recycled vulcanized rubber (RVR) 12 may generally include devulcanized rubber, grounded rubber, reclaimed rubber, or the like, including combinations thereof. By way of further non-limiting example, the waste rubber (feedstock) to produce the RVR may be obtained from end-of-life tires, waste ethylene propylene diene monomer (EPDM) rubber parts, end-of-life butyl rubber tubes, used nitrile gloves, used latex gloves, waste thermoset rubber, or the like, including combinations thereof. The RVR may generally be produced by any known process as desired to suit a particular application, such as devulcanization, reclaiming, and/or cryogenic grounding. The base RVR 12 may generally be produced by any suitable devulcanization process (e.g., mechanical, ultrasonic, chemical, supercritical carbon assisted extrusion, biological, or chemical reclaiming and/or mechanical/cryogenic grounding of rubber, or the like, including combinations thereof).

The one or more foaming agents 30 may be in the form of powders. By way of non-limiting example, the one or more foaming agents 30 may include p-toluenesulfonyl semicarbazide (TSSC), 5-phenyl tetrazole (5-PT), dinitroso pentamethylene tetramine (DPT), carbon monoxide (CO), benzensulfonyl hydrazide (TSH), azodicarbonamide, unexpanded thermoplastic microspheres, supercritical carbon dioxide, or the like, including combinations thereof.

The base RVR 12 may generally be present in the foam rubber composition 10 in any amount as desired to suit a particular application. For example, the amount of base RVR 12 may be varied to produce a product having different a desired density and/or shore hardness, as may be appreciated by those skilled in the art. Similarly, the one or more foaming agents 30 and the one or more processing aids 20 may each generally be present in the foam rubber composition 10 in any respective amount as desired to suit a particular application. By way of non-limiting example, the foam rubber composition 10 may include from about 15 to about 175 parts, per hundred of rubber (PHR), of the base recycled vulcanized rubber 12, from about 3 to about 10 parts, per hundred of rubber (PHR), of the one or more foaming agents 30, and/or from about 1 to about 20 parts, per hundred of rubber (PHR), of the one or more processing aids 20.

The one or more processing aids 20 may optionally include a non-recycled elastomer 40 (e.g., rubber-based), a curative 50, an accelerator 60, an activator 70, a fatty acid 80, a reodorant 90, non-sticking agents, or the like, including combinations thereof.

The optional non-recycled elastomer 40 may be considered as the one or more processing aids 20 or may be provided separately from one or more other processing aids. When provided, the optional non-recycled elastomer 40 may generally be present in the foam rubber composition 10 in any amount as desired to suit a particular application. By way of non-limiting example, the foam rubber composition 10 may include from about 5 to about 70 parts, per hundred of rubber (PHR), of the non-recycled elastomer 40. Any non-recycled elastomer 40 may be employed as desired to suit a particular application. By way of non-limiting example, the non-recycled elastomer 40 may be Styrene-butadiene rubber (SBR) or natural rubber, Polyisoprene, Butyl Rubber (IIR, Isobutene-isoprene), Chloroprene (CR, Neoprene®), Ethylene Propylene Diene (EPDM), Nitrile Butadiene (NBR), Saturated Nitrile (HNBR).

When provided, the optional curative 50 may generally be present in the foam rubber composition 10 in any amount as desired to suit a particular application. By way of non-limiting example, the foam rubber composition 10 may include from about 0.5 to about 5 parts, per hundred of rubber (PHR), of the curative 50. Any curative 50 may be employed as desired to suit a particular application. By way of non-limiting example, the curative 50 may be sulphur, peroxides (e.g., dicumyl peroxide, zinc peroxide, benzoyl peroxide, 2,4-chlorobenzoyl peroxide & 2,5-bis(t-butylperoxy)-2,5-dimethylhexane), Phenolic resins (e.g., hexamethylenetetramine), metal oxide (e.g., zinc oxide & magnesium oxide) based curatives, or the like, including combinations thereof.

When provided, the optional accelerator 60 may generally be present in the foam rubber composition 10 in any amount as desired to suit a particular application. By way of non-limiting example, the foam rubber composition 10 may include from about 0.25 to about 2.25 parts, per hundred of rubber (PHR), of the accelerator 60. Any accelerator 60 may be employed as desired to suit a particular application. By way of non-limiting example, the accelerator 60 may belong to amines group (e.g., Diphenyl guanidine), Dithiocarbamates group (e.g., Zinc diethyl dithiocarbamate), Xanthates group (e.g., Zinc isopropyl xanthate), Sulphenamides group (e.g., N-tert-butyl-benzothiazole sulfonamide (TBBS)), Thiurams group (e.g., tetramethylthiuram disulfide (TMTD)), and Benzothiazoles group (e.g., mercaptobenzothiazole (MBT)), or the like, including combinations thereof.

When provided, the optional activator 70 may generally be present in the foam rubber composition 10 in any amount as desired to suit a particular application. By way of non-limiting example, the foam rubber composition 10 may include from about 1 to about 10 parts, per hundred of rubber (PHR), of the activator 70. Any activator 70 may be employed as desired to suit a particular application. By way of non-limiting example, the activator 70 may be zinc oxide, hydrogen phosphates, tartaric acid or citric acid, or the like, including combinations thereof.

When provided, the optional fatty acid 80 may generally be present in the foam rubber composition 10 in any amount as desired to suit a particular application. By way of non-limiting example, the foam rubber composition 10 may include from about 0.25 to about 10 parts, per hundred of rubber (PHR), of the fatty acid 80. Any fatty acid 80 may be employed as desired to suit a particular application. By way of non-limiting example, the fatty acid 80 may be stearic acid, zinc stearate, zinc 2-ethylhexanoate, or the like, including combinations thereof.

When provided, the optional reodorant 90 may generally be present in the foam rubber composition 10 in any amount as desired to suit a particular application. By way of non-limiting example, the foam rubber composition 10 may include from about 0.2 to about 10 parts, per hundred of rubber (PHR), of the reodorant 90. Any reodorant 90 may be employed as desired to suit a particular application. By way of non-limiting example, the reodorant 90 may be zeolite, chitosan, Zinc-Modified Bentonite, StanMask Cherry, or the like, including combinations thereof.

The foam rubber composition 10 may generally be produced by combining the base recycled vulcanized rubber 12 with the one or more foaming agents 30 and the one or more processing aids 20. Such combining may be achieved by any known process as desired to suit a particular application. By way of non-limiting example, this process for producing the foam rubber composition 10 may be performed at a vulcanization temperature of from about 150 to about 450° F. and/or the curing time range may be from about 5 to about 50 minutes.

As may be appreciated, a variety of products may be constructed from the foam rubber composition 10 described herein. Such a product constructed from the foam rubber composition 10 described herein may advantageously possess high resilience, high compression set, high abrasion resistance, and/or high durability. These unique material properties of the foam rubber composition 10 may be achievable by providing the base RVR 12 and other formulation ingredients (e.g., the one or more foaming agents 30 and/or the one or more processing aids 20) to achieve re-vulcanization and/or renewed cross-linking of polymer chains. There may also be an expected higher cross-linking density in a product constructed from the foam rubber composition 10 due to, e.g., multiple vulcanizations and/or a higher content of carbon black from the base RVR 12 in such product. In aspects, the foam rubber composition 10 may be devoid of any synthetic/petroleum-based and/or natural binding agents or adhesive. In aspects, the foam rubber composition 10 may be devoid of virgin rubber as the base elastomer and/or polluting ingredients (e.g., added carbon black) commonly used in rubber compounds.

Ordinarily, foaming or vulcanization of recycled vulcanized rubber may present challenges due to the cross-linking and thermoset properties of cured rubber being non-reversible like thermoplastic polymers. The devulcanization or reclaiming or grinding of vulcanized rubber may selectively break the Sulphur-Sulphur cross-linked bonds and allow fresh cross-links to be formed in the carbon chain given the newly added Sulphur and other processing aids during the re-vulcanization of the rubber while blowing agents create a porous cell structure to produce foamed rubber. The properties of the resulting foam rubber composition 10 may show superior durability, higher tear strength, higher tensile strength, higher percentage elongation, superior compression set, and/or higher abrasion resistance, such as due to higher cross-linking density of the molded product and/or the inherent presence of a high percentage of carbon black in the base recycled rubber used to produce the molded product. The process for producing the foam rubber composition 10, unlike other traditional approaches for compression molding of RVR with adhesives, utilizes cross-linking and/or vulcanization of rubber and renders different or superior material properties. Moreover, as previously described, rather than reliance on adhesives or the like, the foam rubber composition 10 described herein relies on the ability of the base RVR 12 to form cross-links and harden during a curing and/or molding process via the vulcanization process.

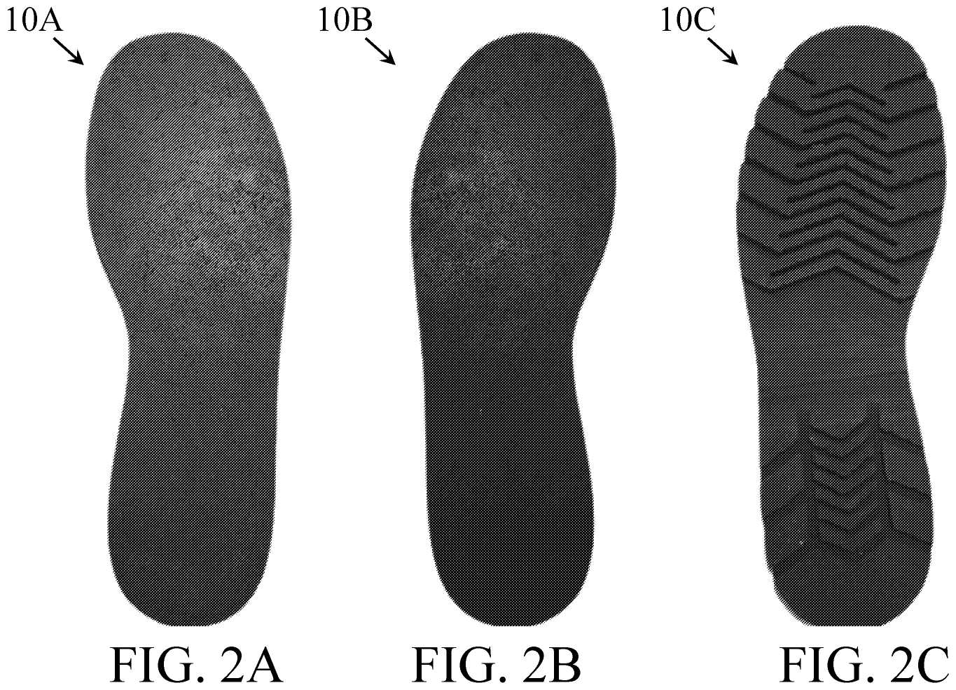

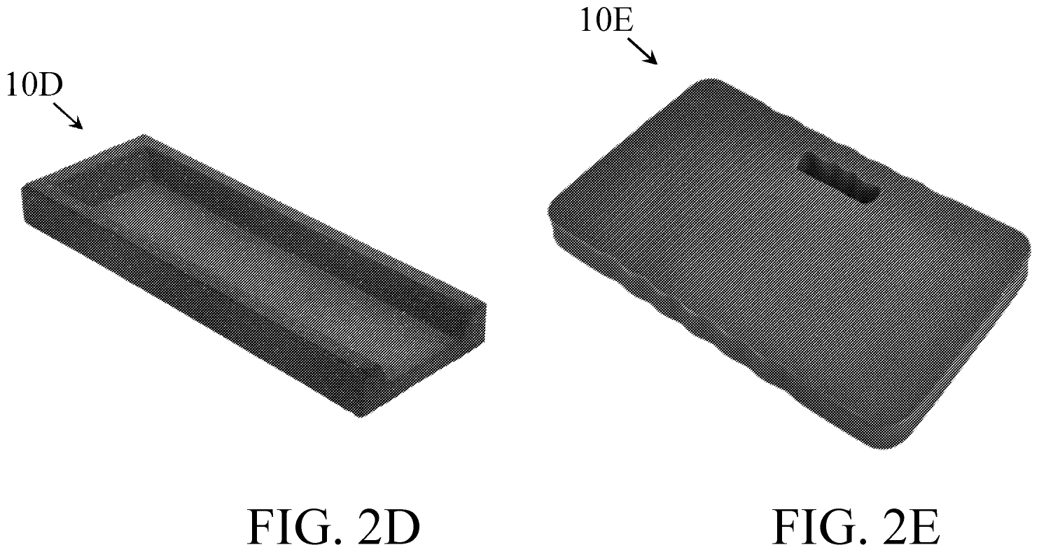

The foam rubber composition 10 described herein may be particularly suitable for applications in footwear components and related parts where a cushioning effect is desired. By way of specific non-limiting example, the foam rubber composition 10 described herein may be used to construct a footwear insole 10A (refer to FIG. 2A), a footwear midsole 10B (refer to FIG. 2B), a footwear outsole 10C (refer to FIG. 2C), a splash block 10D (refer to FIG. 2D), and/or a cushioning pad 10E (refer to FIG. 2E) for use as a seat cushion or knee pad. It is to be recognized that the foam rubber composition 10 described herein may be used to construct a variety of other products as will be appreciated by those skilled in the art. Any such products constructed from the foam rubber composition 10 described herein may advantageously have a density of from about 100 to about 700 kg/m³ and a shore A hardness of from about 10 to about 70.

According to one aspect, a product (e.g., a footwear insole 10A, such as is depicted in FIG. 2A) may be constructed from a foam rubber composition 10 having a formulaic breakdown according to any of Examples 1-15 shown below.

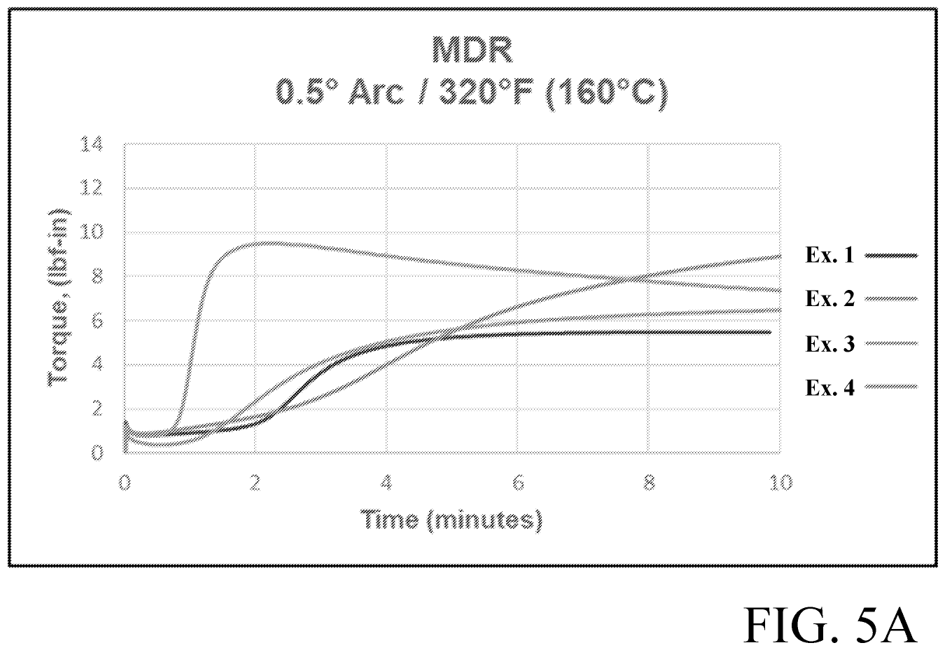

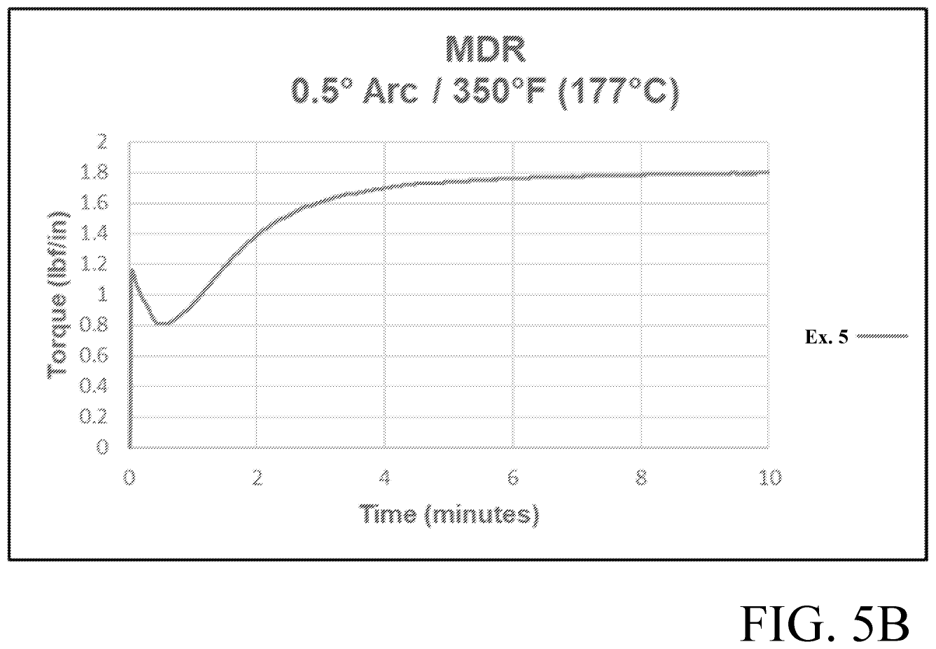

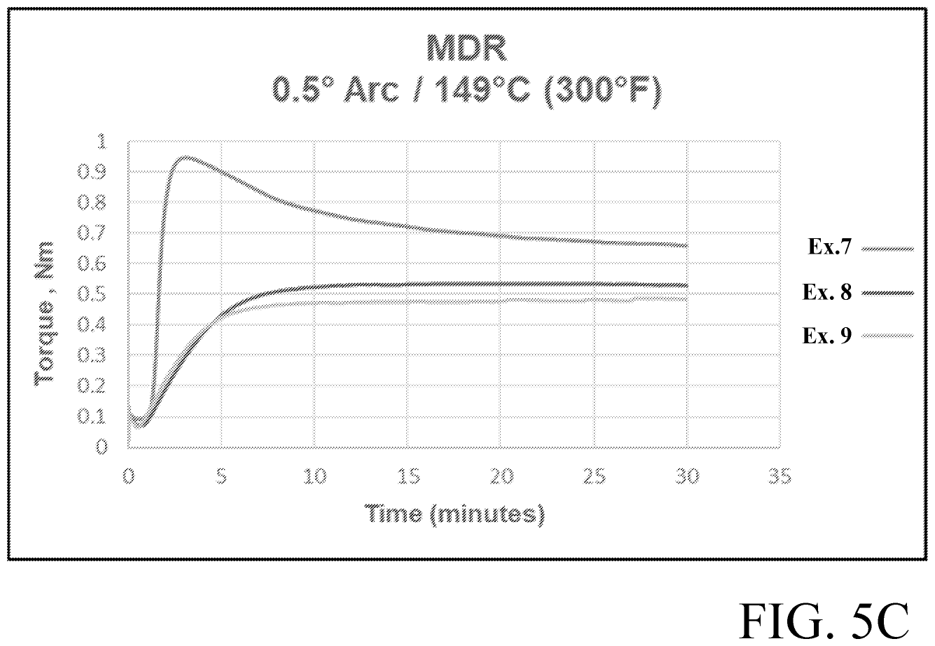

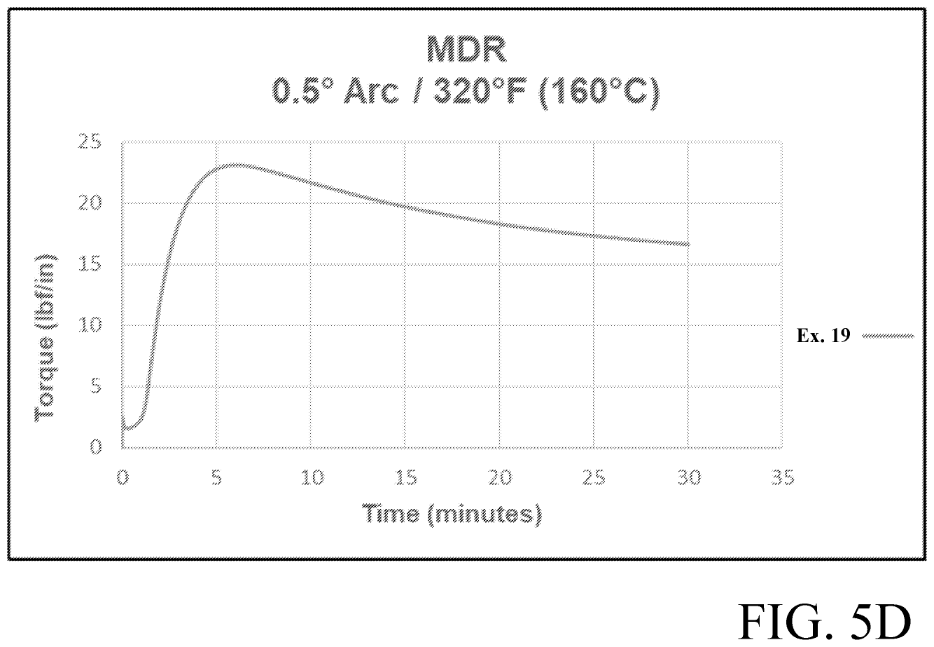

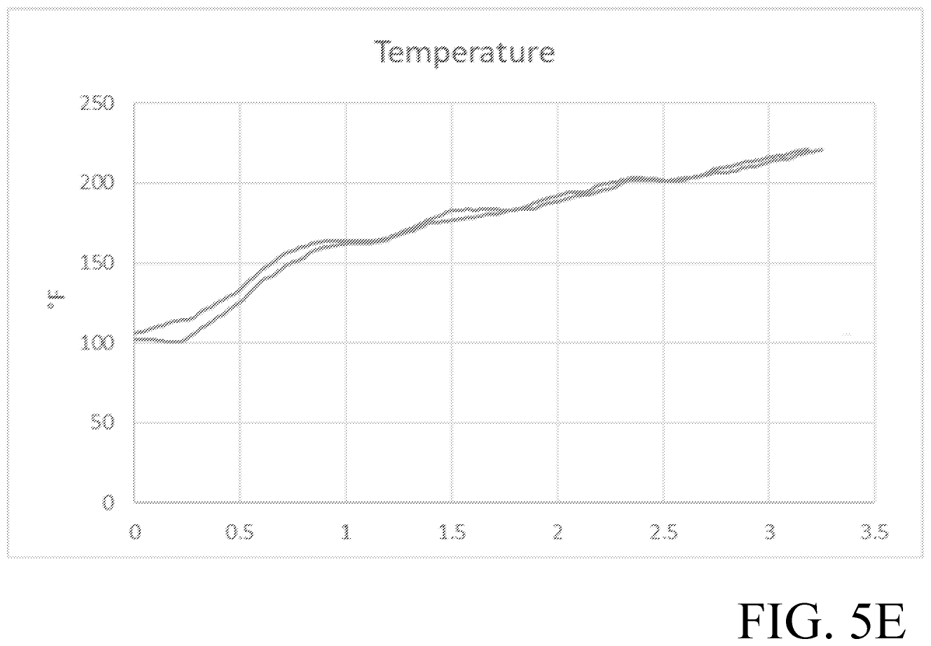

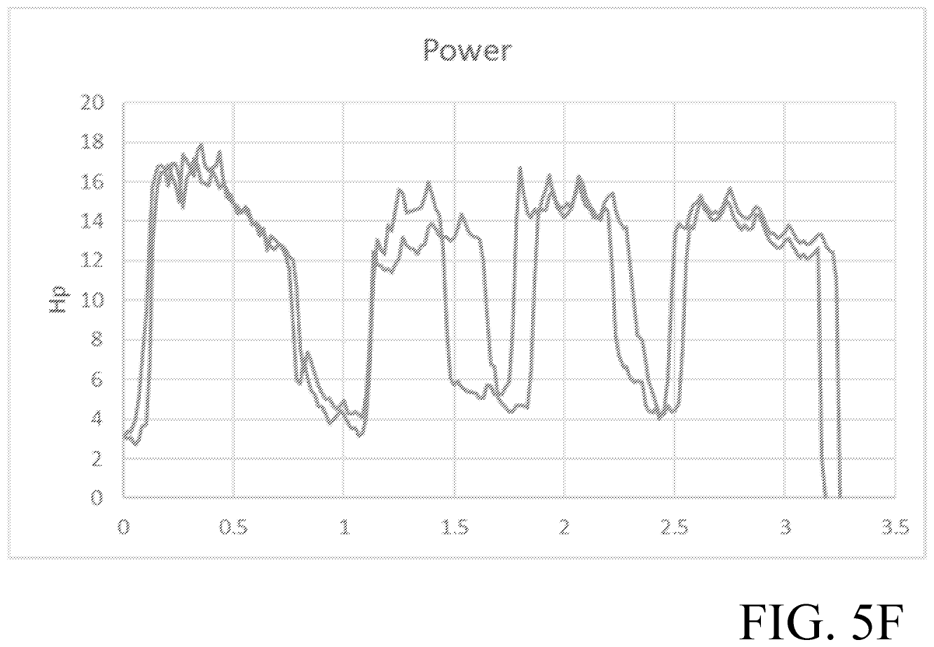

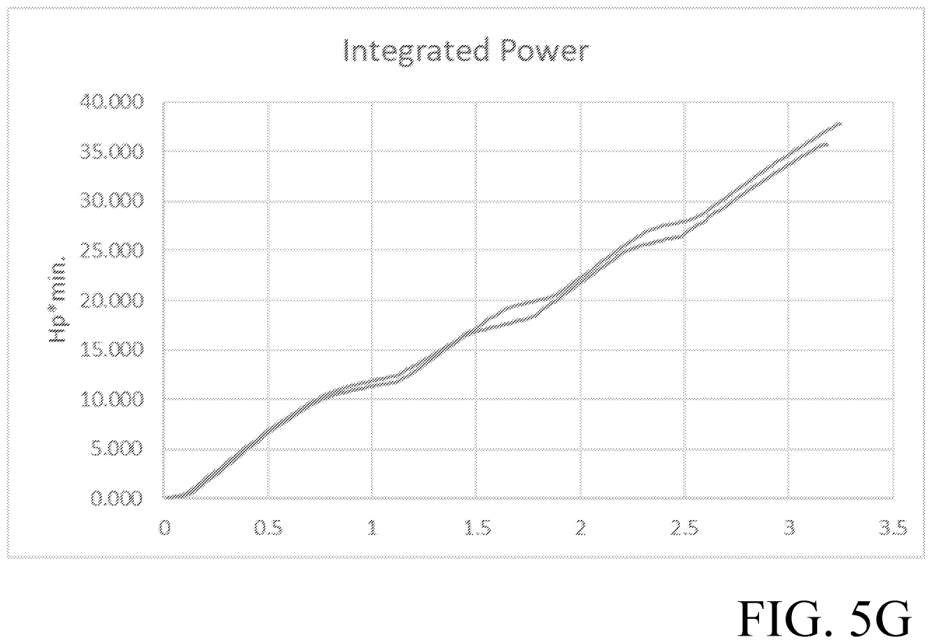

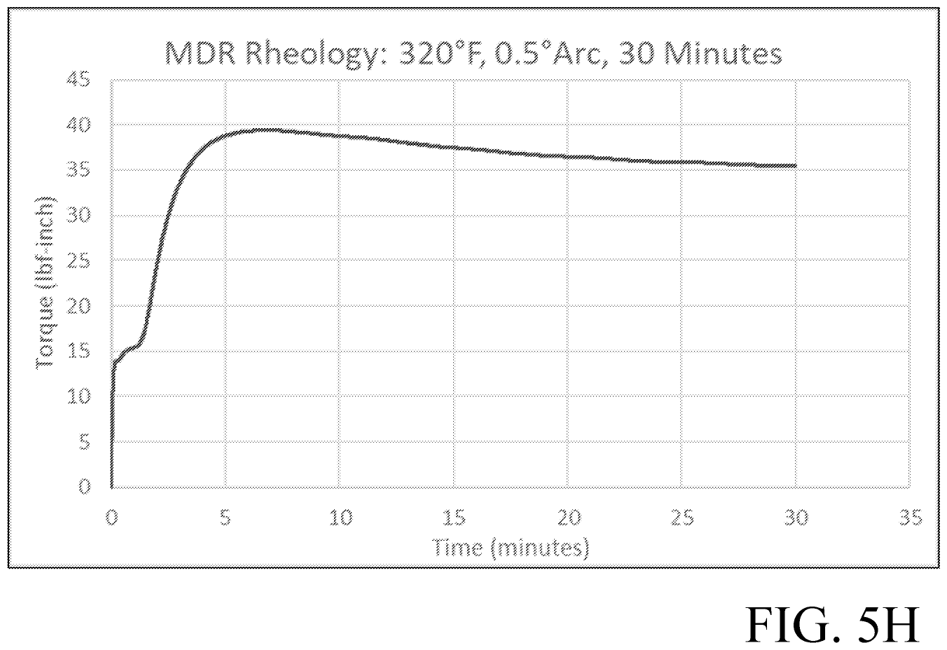

Examples 1-4 were cured at 320° F. for 10 minutes. The rheology data is shown in Table 1 below, and the rheology curve is shown in FIG. 5A. Uncured samples were sheeted out to 0.135″ and cut into 6″×6″ squares and molded at the temperature that the rheology was tested at in a 6″×6″×0.250″ mold. Mold times are shown in Table 2 below.

Example 1

| Material | PHR |
|---|---|
| Base RVR 12 | 150.00 |
| Foaming Agent 30 (Expancell 043 DU 80) | 7.00 |
| Curative 50 (Sulfur) | 1.00 |
| Accelerator 60 (TBBS) | 1.50 |
| Activator 70 (Zinc Oxide) | 3.00 |
| Fatty Acid 80 (Stearic Acid) | 1.00 |
| | 163.50 |

Example 2

| Material | PHR |
|---|---|
| Base RVR 12 | 150.00 |
| Foaming Agent 30 (Celogen AZ 780) | 7.00 |
| Curative 50 (Sulfur) | 1.00 |
| Accelerator 60 (TBBS) | 1.50 |
| Activator 70 (Zinc Oxide) | 3.00 |
| Fatty Acid 80 (Stearic Acid) | 1.00 |
| | 163.50 |

Example 3

| Material | PHR |
|---|---|
| Base RVR 12 | 100.00 |
| Foaming Agent 30 (Expancell 043 DU 80) | 7.00 |
| Curative 50 (Sulfur) | 2.00 |
| Accelerator 60 (TMTD) | 1.75 |
| | 110.75 |

Example 4

| Material | PHR |
|---|---|
| Base RVR 12 | 150.00 |
| Foaming Agent 30 (Celogen AZ 780) | 2.00 |
| Foaming Agent 30 (Baking Soda) | 10.00 |
| Curative 50 (Sulfur) | 2.50 |
| Accelerator 60 (TMTD) | 0.25 |
| Accelerator 60 (MBT) | 2.00 |
| Activator 70 (Zinc Oxide) | 5.00 |
| Fatty Acid 80 (Stearic Acid) | 15.00 |
| | 186.75 |

TABLE 1

| | | Cure | Cure | Scorch | |
|---|---|---|---|---|---|
| | Min Torque, | Time, | Time, | Time, | Max Torque, |
| | ML, lbf-inch | T50, min | T90, min | TS1, min | MH, lbf-inch |
| Ex. 1 | 0.81 | 2.77 | 4.26 | 2.28 | 5.48 |
| Ex. 2 | 0.90 | 5.91 | 19.45 | 2.34 | 12.21 |
| Ex. 3 | 0.78 | 1.05 | 1.41 | 0.85 | 9.51 |
| Ex. 4 | 0.38 | 2.73 | 9.44 | 1.49 | 7.10 |

TABLE 2

| | Mold Time, min | Temperature, ° F. |
|---|---|---|
| Ex. 1 | 5 | 320 |
| Ex. 2 | 20 | 320 |
| Ex. 3 | 2 | 320 |
| Ex. 4 | 10 | 320 |

Example 5 was cured at 350° F. for 10 minutes. The rheology data is shown in Table 3 below, and the rheology curve is shown in FIG. 5B. Uncured samples were sheeted out to 0.135″ and cut into 6″×6″ squares and molded at the temperature that the rheology was tested at in a 6″×6″×0.250″ mold. Mold time is shown in Table 4 below.

Example 5

| Material | PHR |
|---|---|
| Base RVR 12 | 108.5 |
| Foaming Agent 30 (Baking Soda) | 2.40 |
| Foaming Agent 30 (Celogen OT) | 5.10 |
| Non-Recycled Elastomer 40 (SMR CV60 Natural Rubber) | 50.50 |
| Curative 50 (Sulfur) | 0.72 |
| Accelerator 60 (TBBS) | 0.72 |
| Activator 70 (Zinc Oxide) | 3.65 |
| Fatty Acid 80 (Stearic Acid) | 0.72 |
| | 172.31 |

TABLE 3

| | | Cure | Cure | Scorch | |
|---|---|---|---|---|---|
| | Min Torque, | Time, | Time, | Time, | Max Torque, |
| | ML, lbf-inch | T50, min | T90, min | TS1, min | MH, lbf-inch |
| Ex. 5 | 0.81 | 1.74 | 3.95 | 3.95 | 1.80 |

TABLE 4

| | Mold Time, min | Temperature, ° F. |
|---|---|---|
| Ex. 1 | 10 | 350 |

Examples 7-9 were cured at 300° F. for 5, 7, and 6 minutes, respectively. A one-pass mix was performed in which the non-recycled elastomer 40 (SMR CV60 natural rubber) was added at 0:00, the base RVR 12 was added at 0:30, the remaining ingredients were added at 1:00, and a drop at 210° F. The rheology data is shown in Table 5 below, and the rheology curve is shown in FIG. 5C. Examples 7-9 were molded into 12″×12″×0.25″ slabs.

Example 6

| Material | PHR |
|---|---|
| Base RVR 12 | 80.00 |
| Foaming Agent 30 (Expancell 043 DU 80) | 10.00 |
| Non-Recycled Elastomer 40 (SMR CV60 Natural Rubber) | 20.00 |
| Curative 50 (Sulfur) | 2.00 |
| Accelerator 60 (TMTD) | 1.75 |
| Processing Aid 20 (Struktol WB 222) | 2.00 |
| | 115.75 |

Example 7

| Material | PHR |
|---|---|
| Base RVR 12 | 80.00 |
| Foaming Agent 30 (Expancell 950 DU 80) | 7.00 |
| Non-Recycled Elastomer 40 (SMR CV60 Natural Rubber) | 20.00 |
| Curative 50 (Sulfur) | 2.00 |
| Accelerator 60 (TMTD) | 1.75 |
| Processing Aid 20 (Struktol WB 222) | 2.00 |
| | 112.75 |

Example 8

| Material | PHR |
|---|---|
| Base RVR 12 | 80.00 |
| Foaming Agent 30 (Baking Soda) | 2.40 |
| Foaming Agent 30 (Celogen OT) | 5.10 |
| Foaming Activator (BIK) | 2.00 |
| Non-Recycled Elastomer 40 (SMR CV60 Natural Rubber) | 20.00 |
| Curative 50 (Sulfur) | 2.00 |
| Accelerator 60 (TBBS) | 1.00 |
| Activator 70 (Zinc Oxide) | 3.65 |
| Fatty Acid 80 (Stearic Acid) | 0.72 |
| Processing Aid 20 (Struktol WB 222) | 2.00 |
| | 118.87 |

Example 9

| Material | PHR |
|---|---|
| Base RVR 12 | 80.00 |
| Foaming Agent 30 (Baking Soda) | 2.40 |
| Foaming Agent 30 (Celogen OT) | 5.10 |
| Foaming Agent 30 (Citric Acid) | 2.00 |
| Foaming Activator (BIK) | 2.00 |
| Non-Recycled Elastomer 40 (SMR CV60 Natural Rubber) | 20.00 |
| Curative 50 (Sulfur) | 2.00 |
| Accelerator 60 (TBBS) | 1.00 |
| Activator 70 (Zinc Oxide) | 3.65 |
| Fatty Acid 80 (Stearic Acid) | 0.72 |
| Processing Aid 20 (Struktol WB 222) | 2.00 |
| | 120.87 |

TABLE 5

| | Min | Cure | Cure | | |
|---|---|---|---|---|---|
| | Torque, | Time, | Time, | Scorch Time, | Max Torque, |
| | ML, Nm | T50, min | T90, min | TS1, min | MH, Nm |
| Ex. 7 | 0.09 | 1.66 | 2.18 | 1.39 | 0.95 |
| Ex. 8 | 0.07 | 3.15 | 6.78 | 1.94 | 0.54 |
| Ex. 9 | 0.07 | 2.58 | 5.99 | 1.65 | 0.49 |

Examples 10-12 were carried out by adding various levels of natural rubber to Example 1 to reduce sticking and add aroma to the product. Examples 10-12 were cured at 320° F. for 5 minutes. A one-pass mix was performed in which the non-recycled elastomer 40 (SMR CV60 natural rubber) was added at 0:00, the base RVR 12 was added at 0:30, the remaining ingredients were added at 1:00, a sweep was performed at 160° F., and a drop at 180° F. Examples 10-12 were molded into 12″×12″×0.25″ pads.

Example 10

| Material | PHR |
|---|---|
| Base RVR 12 | 140.00 |
| Foaming Agent 30 (Expancell 043 DU 80) | 7.00 |
| Non-Recycled Elastomer 40 (SMR CV60 Natural Rubber) | 10.00 |
| Curative 50 (Sulfur) | 1.00 |
| Accelerator 60 (TBBS) | 1.50 |
| Activator 70 (Zinc Oxide) | 3.00 |
| Fatty Acid 80 (Stearic Acid) | 1.00 |
| Reodorant 90 (Stanmask Cherry) | 0.50 |
| | 164.00 |

Example 11

| Material | PHR |
|---|---|
| Base RVR 12 | 130.00 |
| Foaming Agent 30 (Expancell 043 DU 80) | 7.00 |
| Non-Recycled Elastomer 40 (SMR CV60 Natural Rubber) | 20.00 |
| Curative 50 (Sulfur) | 1.00 |
| Accelerator 60 (TBBS) | 1.50 |
| Activator 70 (Zinc Oxide) | 3.00 |
| Fatty Acid 80 (Stearic Acid) | 1.00 |
| Reodorant 90 (Stanmask Cherry) | 0.20 |
| | 163.70 |

Example 12

| Material | PHR |
|---|---|
| Base RVR 12 | 100.00 |
| Foaming Agent 30 (Expancell 043 DU 80) | 7.00 |
| Non-Recycled Elastomer 40 (SMR CV60 Natural Rubber) | 50.00 |
| Curative 50 (Sulfur) | 1.00 |
| Accelerator 60 (TBBS) | 1.50 |
| Activator 70 (Zinc Oxide) | 3.00 |
| Fatty Acid 80 (Stearic Acid) | 1.00 |
| Reodorant 90 (Stanmask Cherry) | 0.60 |
| | 164.10 |

Examples 13-15 were conducted to determine if the thickness of the uncured rubber going into the mold effected foam density. Examples 13-15 were cured at 320° F. for 5 minutes in a 3″×3″×0.25″ mold. Example 13 was run at thickness levels of 0.15″, 0.25″, and 0.35″, Example 14 was run at thickness levels of 0.25″ and 0.35″, and Example 15 was run at thickness levels of 0.18″, 0.25″, and 0.31″. Generally, the larger thicknesses were found to exhibit better surface appearance and higher density hand feel.

Example 13

| Material | PHR |
|---|---|
| Base RVR 12 | 140.00 |
| Foaming Agent 30 (Expancell 930 DU 120) | 7.00 |
| Non-Recycled Elastomer 40 (SMR CV60 Natural Rubber) | 10.00 |
| Curative 50 (Sulfur) | 1.00 |
| Accelerator 60 (TBBS) | 1.50 |
| Activator 70 (Zinc Oxide) | 3.00 |
| Fatty Acid 80 (Stearic Acid) | 1.00 |
| Reodorant 90 (Stanmask Cherry) | 0.50 |
| | 164.00 |

Example 14

| Material | PHR |
|---|---|
| Base RVR 12 | 140.00 |
| Foaming Agent 30 (Celogen AZ 130) | 7.00 |
| Non-Recycled Elastomer 40 (SMR CV60 Natural Rubber) | 10.00 |
| Curative 50 (Sulfur) | 0.80 |
| Accelerator 60 (TBBS) | 0.80 |
| Activator 70 (Zinc Oxide) | 3.00 |
| Fatty Acid 80 (Stearic Acid) | 1.00 |
| Reodorant 90 (Stanmask Cherry) | 0.50 |
| | 163.10 |

Example 15

| Material | PHR |
|---|---|
| Base RVR 12 | 140.00 |
| Foaming Agent 30 (Celogen AZ 130) | 7.00 |
| Non-Recycled Elastomer 40 (SMR CV60 Natural Rubber) | 10.00 |
| Curative 50 (Sulfur) | 0.80 |
| Accelerator 60 (TBBS) | 0.80 |
| Activator 70 (Zinc Oxide) | 3.00 |
| Fatty Acid 80 (Stearic Acid) | 1.00 |
| Reodorant 90 (Stanmask Cherry) | 0.50 |
| Foaming Activator (Acticell U) | 3.00 |
| | 166.10 |

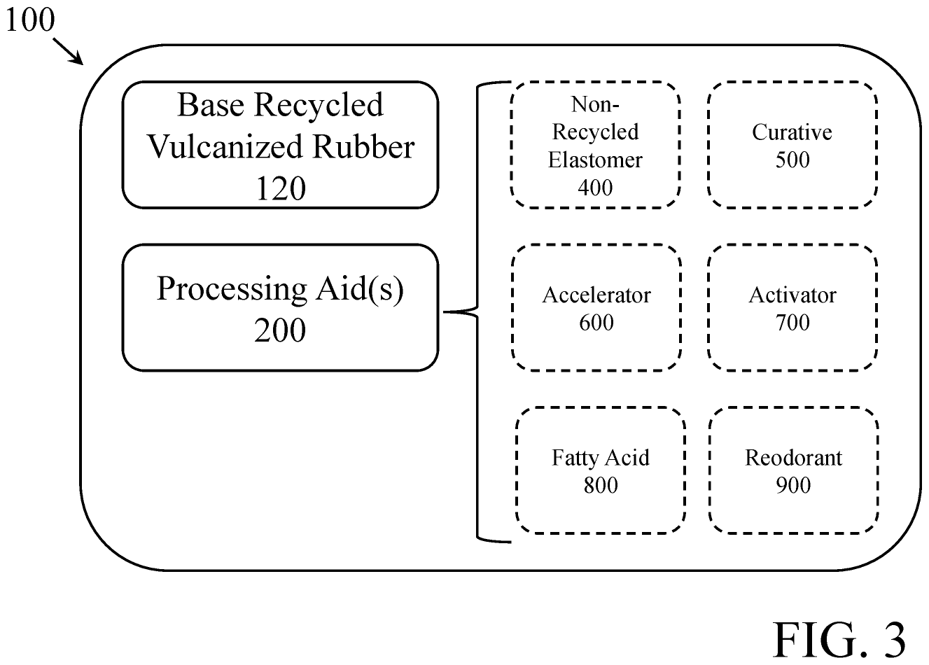

Referring to FIG. 3, features of a solid rubber composition 100 according to one aspect may be seen and will be described. The solid rubber composition 100 includes a base recycled vulcanized rubber 120 and one or more processing aids 200.

The base recycled vulcanized rubber (RVR) 120 may generally include devulcanized rubber, grounded rubber, reclaimed rubber, or the like, including combinations thereof. By way of further non-limiting example, the waste rubber (feedstock) to produce the RVR may be obtained from end-of-life tires, waste ethylene propylene diene monomer (EPDM) rubber parts, end-of-life butyl rubber tubes, used nitrile gloves, used latex gloves, waste thermoset rubber, or the like, including combinations thereof. The RVR may generally be produced by any known process as desired to suit a particular application, such as devulcanization, reclaiming, and/or cryogenic grounding.

The base RVR 120 may generally be present in the solid rubber composition 100 in any amount as desired to suit a particular application. For example, the amount of base RVR 120 may be varied to produce a product having different a desired density and/or shore hardness, as may be appreciated by those skilled in the art. Similarly, the one or more processing aids 200 may also generally be present in the solid rubber composition 100 in any amount as desired to suit a particular application. By way of non-limiting example, the solid rubber composition 100 may include from about 15 to about 175 parts, per hundred of rubber (PHR), of the base recycled vulcanized rubber 120 and/or from about 1 to about 95 parts, per hundred of rubber (PHR), of the one or more processing aids 200.

The one or more processing aids 200 may optionally include a non-recycled elastomer 400 (e.g., rubber-based), a curative 500, an accelerator 600, an activator 700, a fatty acid 800, a reodorant 900, or the like, including combinations thereof.

The optional non-recycled elastomer 400 may be considered as the one or more processing aids 200 or may be provided separately from one or more other processing aids. When provided, the optional non-recycled elastomer 400 may generally be present in the solid rubber composition 100 in any amount as desired to suit a particular application. By way of non-limiting example, the solid rubber composition 100 may include from about 5 to about 100 parts, per hundred of rubber (PHR), of the non-recycled elastomer 400. Any non-recycled elastomer 400 may be employed as desired to suit a particular application. By way of non-limiting example, the non-recycled elastomer 400 may be Styrene-butadiene rubber (SBR) or natural rubber, Polyisoprene, Butyl Rubber (IIR, Isobutene-isoprene), Chloroprene (CR, Neoprene®), Ethylene Propylene Diene (EPDM), Nitrile Butadiene (NBR), Saturated Nitrile (HNBR).

When provided, the optional curative 500 may generally be present in the solid rubber composition 100 in any amount as desired to suit a particular application. By way of non-limiting example, the solid rubber composition 100 may include from about 0.5 to about 10 parts, per hundred of rubber (PHR), of the curative 500. Any curative 500 may be employed as desired to suit a particular application. By way of non-limiting example, the curative 500 may be sulphur, peroxides (e.g., dicumyl peroxide, zinc peroxide, benzoyl peroxide, 2,4-chlorobenzoyl peroxide & 2,5-bis(t-butylperoxy)-2,5-dimethylhexane), Phenolic resins (e.g., hexamethylenetetramine), metal oxide (e.g., zinc oxide & magnesium oxide) based curatives, or the like, including combinations thereof.

When provided, the optional accelerator 600 may generally be present in the solid rubber composition 100 in any amount as desired to suit a particular application. By way of non-limiting example, the solid rubber composition 100 may include from about 0.25 to about 5 parts, per hundred of rubber (PHR), of the accelerator 600. Any accelerator 600 may be employed as desired to suit a particular application. By way of non-limiting example, the accelerator 600 may be belong to amines group (e.g., Diphenyl guanidine) or Dithiocarbamates group (e.g., Zinc diethyl dithiocarbamate), Xanthates group (e.g. Zinc isopropyl xanthate), Sulphenamides group (e.g., N-tert-butyl-benzothiazole sulfonamide (TBBS)), Thiurams group (e.g. tetramethylthiuram disulfide (TMTD)), and Benzothiazoles group (e.g., mercaptobenzothiazole (MBT)), or the like, including combinations thereof.

When provided, the optional activator 700 may generally be present in the solid rubber composition 100 in any amount as desired to suit a particular application. By way of non-limiting example, the solid rubber composition 100 may include from about 1 to about 10 parts, per hundred of rubber (PHR), of the activator 700. Any activator 700 may be employed as desired to suit a particular application. By way of non-limiting example, the activator 700 may be zinc oxide, hydrogen phosphates, tartaric acid, citric acid, or the like, including combinations thereof.

When provided, the optional fatty acid 800 may generally be present in the solid rubber composition 100 in any amount as desired to suit a particular application. By way of non-limiting example, the solid rubber composition 100 may include from about 0.25 to about 10 parts, per hundred of rubber (PHR), of the fatty acid 800. Any fatty acid 800 may be employed as desired to suit a particular application. By way of non-limiting example, the fatty acid 800 may be stearic acid, zinc stearate, zinc 2-ethylhexanoate, or the like, including combinations thereof.

When provided, the optional reodorant 900 may generally be present in the solid rubber composition 100 in any amount as desired to suit a particular application. By way of non-limiting example, the solid rubber composition 100 may include from about 0.2 to about 10 parts, per hundred of rubber (PHR), of the reodorant 900. Any reodorant 900 may be employed as desired to suit a particular application. By way of non-limiting example, the reodorant 900 may be zeolite, chitosan, Zinc-Modified Bentonite, StanMask Cherry, or the like, including combinations thereof.

The solid rubber composition 100 may generally be produced by combining the base recycled vulcanized rubber 120 with the one or more processing aids 200. Such combining may be achieved by any known process as desired to suit a particular application. By way of non-limiting example, this process for producing the solid rubber composition 100 may be performed at a vulcanization temperature of from about 150 to about 450° F. and/or the curing time range may be from about 5 to about 50 minutes.

As may be appreciated, a variety of products may be constructed from the solid rubber composition 100 described herein. Such a product constructed from the solid rubber composition 100 described herein may advantageously possess high shock absorption, high tensile and tear strength, higher percent elongation, high abrasion resistance, and/or high durability. These unique material properties of the solid rubber composition 100 may be achievable by providing the base RVR 120 and other formulation ingredients (e.g., the one or more processing aids 200) to achieve re-vulcanization and/or renewed cross-linking of polymer chains. In aspects, the solid rubber composition 100 may be devoid of any synthetic/petroleum-based and/or natural binding agents or adhesive. In aspects, the solid rubber composition 100 may be devoid of virgin rubber products as base elastomer and/or polluting ingredients (e.g., added carbon black) commonly used in rubber compounds.

Ordinarily, vulcanization of recycled vulcanized rubber may present challenges due to the cross-linking and thermoset properties of cured rubber being non-reversible like thermoplastic polymers. The devulcanization or reclaiming or grinding of rubber may selectively break the Sulphur-Sulphur cross-linked bonds and allow fresh cross-links to be formed in the carbon chain given the newly added Sulphur and other processing aids during the re-vulcanization of the rubber produce solid molded rubber. The properties of the resulting foam rubber composition 10 may show superior durability, high tensile strength, higher tear strength, superior compression set, and/or abrasion resistance, such as due to higher cross-linking density of the molded product and/or the inherent presence of a high percentage of carbon black in the base recycled rubber used to produce the molded product. The process for producing the solid rubber composition 100, unlike other traditional compression molding approaches, utilizes cross-linking and/or vulcanization of rubber and renders different or superior material properties. Moreover, as previously described, rather than reliance on adhesives or the like, the solid rubber composition 100 described herein relies on the ability of the base RVR 120 to form cross-links and harden during a curing and/or molding process via the vulcanization process.

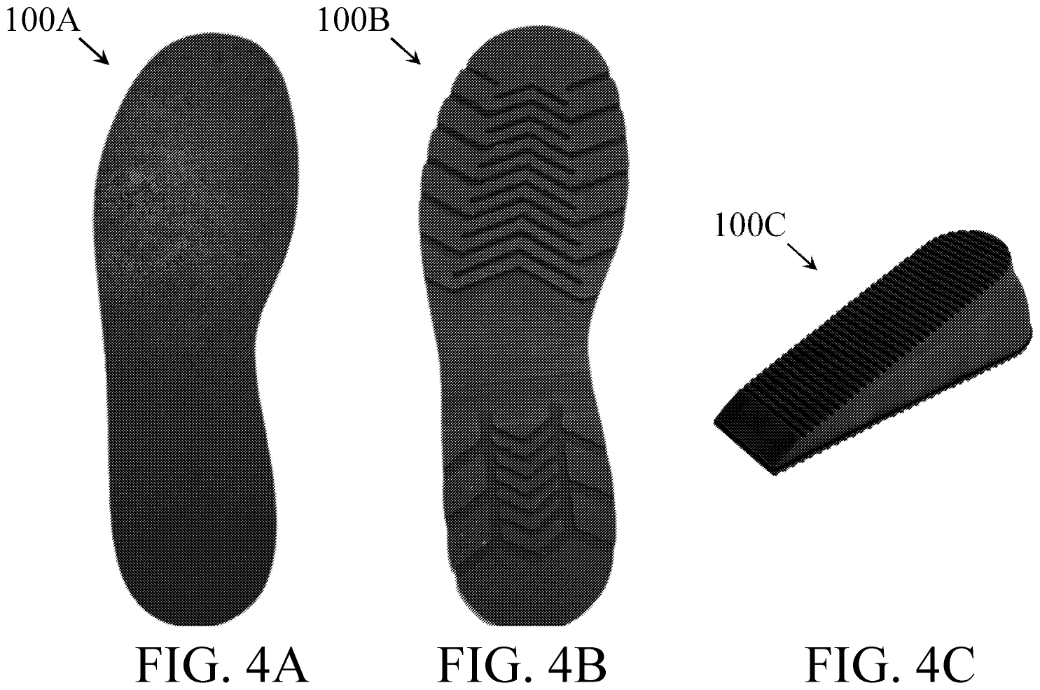

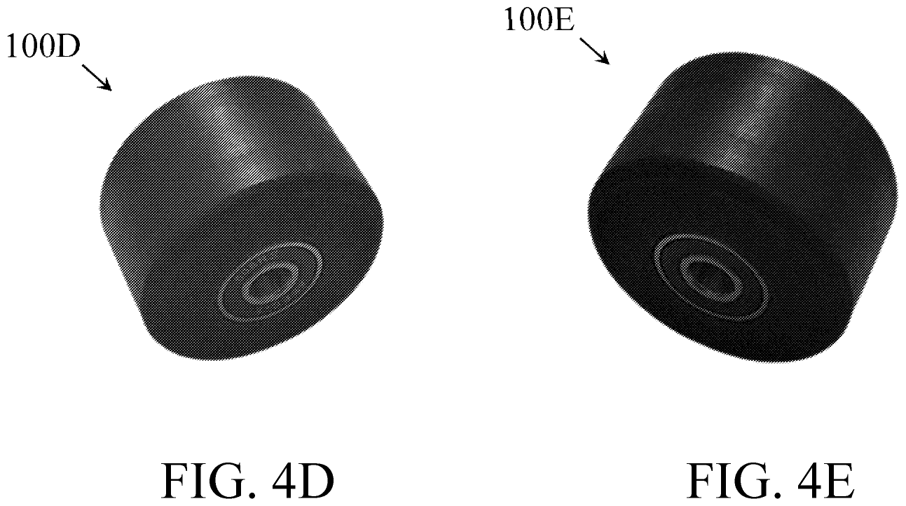

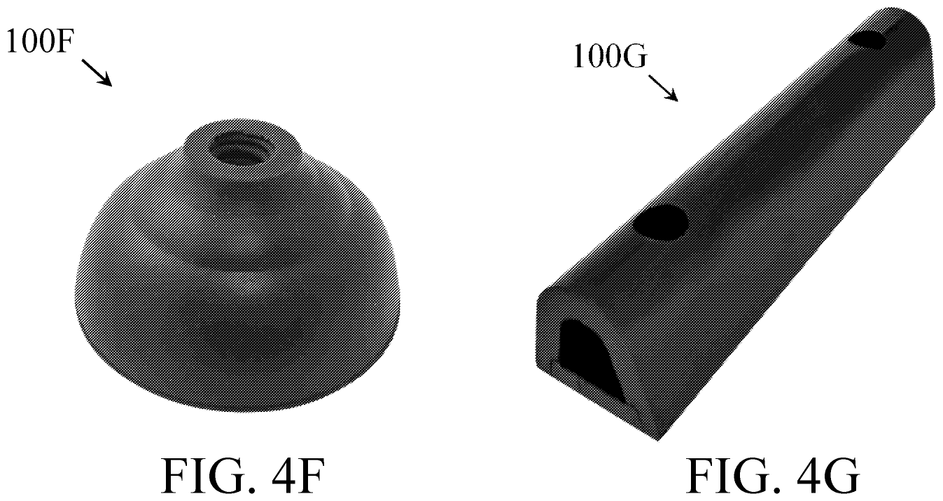

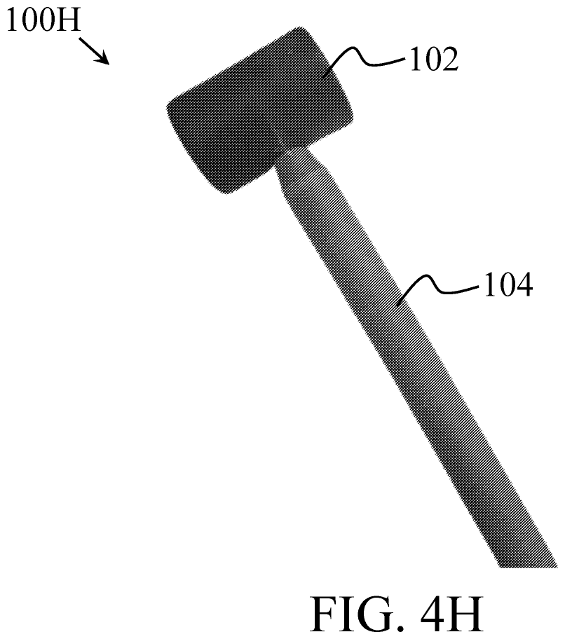

The solid rubber composition 100 described herein may be particularly suitable for applications in footwear components and related parts where a more durable effect is desired. By way of specific non-limiting example, the solid rubber composition 100 described herein may be used to construct a footwear midsole 100A (refer to FIG. 4A), a footwear outsole 100B (refer to FIG. 4B), a door wedge 100C (refer to FIG. 4C), a skateboard wheel 100D (refer to FIG. 4D), a caster 100E (refer to FIG. 4E), a toilet plunger head 100F (refer to FIG. 4F), a marine fender 100G (refer to FIG. 4G), and/or a head 102 for a mallet 100H (refer to FIG. 4H). It is to be recognized that the solid rubber composition 100 described herein may be used to construct a variety of other products as will be appreciated by those skilled in the art. A product, such as a footwear outsole 100B (refer to FIG. 4B), constructed from the solid rubber composition 100 described herein may advantageously have a density of from about 400 to about 1600 kg/m³ and a shore A hardness of from about 50 to about 100. Another product, such as a skateboard wheel 100D (refer to FIG. 4D), a caster 100E (refer to FIG. 4E), a marine fender 100G (refer to FIG. 4G), and/or a head 102 for a mallet 100H (refer to FIG. 4H), constructed from the solid rubber composition 100 described herein may advantageously have a density of from about 700 to about 1600 kg/m³ and a shore A hardness of from about 60 to about 110.

According to one aspect, a product (e.g., a footwear outsole 100A, such as is depicted in FIG. 4A) may be constructed from a solid rubber composition 100 having a formulaic breakdown according to any of Examples 16-19 shown below. The formulaic breakdowns of Examples 16-19 were designed to make such product oil-resistant and/or non-marking.

Example 16

| Material | PHR |
|---|---|
| Base RVR 120 | 50.00 |
| Non-Recycled Elastomer 400 (SMR CV60 Natural Rubber) | 30.00 |
| Non-Recycled Elastomer 400 (Nitrile butadiene rubber | 20.00 |
| (NBR) or Hydrogenated Nitrile Butadiene Rubber (HNBR)) | |
| Curative 500 (Sulfur) | 3.00 |
| Accelerator 600 (TBBS) | 1.00 |
| Activator 700 (Zinc Oxide) | 3.00 |
| Fatty Acid 800 (Stearic Acid) | 1.00 |
| Processing Aid 200 (Hi-Sil 532EP Silica) | 15.00 |
| | 123.00 |

Example 17

| Material | PHR |
|---|---|
| Base RVR 120 | 25.00 |
| Non-Recycled Elastomer 400 (SMR CV60 Natural Rubber) | 60.00 |
| Non-Recycled Elastomer 400 (Nitrile butadiene rubber | 15.00 |
| (NBR) or Hydrogenated Nitrile Butadiene Rubber (HNBR)) | |
| Curative 500 (Sulfur) | 3.00 |
| Accelerator 600 (TBBS) | 1.00 |
| Activator 700 (Zinc Oxide) | 3.00 |
| Fatty Acid 800 (Stearic Acid) | 1.00 |
| Processing Aid 200 (Hi-Sil 532EP Silica) | 15.00 |
| | 123.00 |

Example 18

| Material | PHR |
|---|---|
| Base RVR 120 | 35.00 |
| Non-Recycled Elastomer 400 (SMR CV60 Natural Rubber) | 45.00 |
| Non-Recycled Elastomer 400 (Nitrile butadiene rubber | 20.00 |
| (NBR) or Hydrogenated Nitrile Butadiene Rubber (HNBR)) | |
| Curative 500 (Sulfur) | 3.00 |
| Accelerator 600 (TBBS) | 1.00 |
| Activator 700 (Zinc Oxide) | 3.00 |
| Fatty Acid 800 (Stearic Acid) | 1.00 |
| Processing Aid 200 (Hi-Sil 532EP Silica) | 15.00 |
| | 123.00 |

Example 19

| Material | PHR |
|---|---|
| Base RVR 120 | 30.00 |
| Non-Recycled Elastomer 400 (SMR CV60 Natural Rubber) | 50.00 |
| Non-Recycled Elastomer 400 (Nitrile butadiene rubber | 20.00 |
| (NBR) or Hydrogenated Nitrile Butadiene Rubber (HNBR)) | |
| Curative 500 (Sulfur) | 3.00 |
| Accelerator 600 (TBBS) | 1.00 |
| Activator 700 (Zinc Oxide) | 3.00 |
| Fatty Acid 800 (Stearic Acid) | 1.00 |
| Processing Aid 200 (Hi-Sil 532EP Silica) | 45.00 |
| | 153.00 |

According to another aspect, a product (e.g., a footwear outsole 100A, such as is depicted in FIG. 4A) may be constructed from a solid rubber composition 100 having a formulaic breakdown according to Example 20 shown below. Example 20 was cured at 320° F. for 15 minutes. The rheology data is shown in Table 6 below, and the rheology curve is shown in FIG. 5D. Example 20 was molded into two 12″×12″×0.5″ sheets. A one-pass mix was performed in which the base RVR 120 and stearic acid were added at 0:00, the activator (zinc oxide) and silica (Hi-Sil 532EP) were added at 0:45, and the remaining ingredients (TBB and sulfur) were added at 180° F., a sweep was performed at 200° F., and a drop at 200° F. The mixing data temperature, power, and integrated power are shown in FIGS. 5E, 5F, and 5G, respectively.

Example 20

| Material | PHR |
|---|---|
| Base RVR 120 | 100.00 |
| Curative 500 (Sulfur) | 3.00 |
| Accelerator 600 (TBBS) | 1.00 |
| Activator 700 (Zinc Oxide) | 3.00 |
| Fatty Acid 800 (Stearic Acid) | 1.00 |
| Processing Aid 200 (Hi-Sil 532EP Silica) | 15.00 |
| | 123.00 |

TABLE 6

| | Min | Cure | Cure | Scorch | Max |
|---|---|---|---|---|---|
| | Torque, ML, | Time, | Time, | Time, | Torque, MH, |
| | lbf-inch | T50, min | T90, min | TS1, min | lbf-inch |
| Ex. 19 | 1.54 | 2.05 | 3.76 | 1.04 | 23.08 |

According to another aspect, a product (e.g., a skateboard wheel 100D, such as is depicted in FIG. 4D, a caster 100E, such as is depicted in FIG. 4E, a marine fender 100G, such as is depicted in FIG. 4G, and/or a head 102 for a mallet 100H, such as is depicted in FIG. 4H) may be constructed from a solid rubber composition 100 having a formulaic breakdown according to Example 21 shown below. Example 21 was cured at 320° F. for 6 minutes. The rheology data is shown in Table 7 below, and the rheology curve is shown in FIG. 5H. Example 21 was molded into compression set buttons, and durometer was tested and the data is shown in Table 8 below. A one-pass mix was performed in which the base RVR 120 and stearic acid were added at 0:00, the activator (zinc oxide) and silica (Hi-Sil 532EP) were added at 0:45, and the remaining ingredients (TBB and sulfur) were added at 180° F., a sweep was performed at 200° F., and a drop at 200° F. The mixing data temperature, power, and integrated power are shown in FIGS. 5E, 5F, and 5G, respectively.

Example 21

| Material | PHR |
|---|---|
| Base RVR 120 | 100.00 |
| Processing Aid 200 (HiSil 532EP) | 45.00 |
| Curative 500 (Sulfur) | 2.00 |
| Accelerator 600 (TBBS) | 1.00 |
| Activator 700 (Zinc Oxide) | 3.00 |
| Fatty Acid 800 (Stearic Acid) | 1.00 |
| Processing Aid 200 (Struktol WB 222) | 2.00 |
| Processing Aid 200 (Sundex 790 Aromatic Oil) | 5.00 |
| | 159.00 |

TABLE 7

| | Min Torque, | Cure Time, | Scorch Time, | Max Torque, |
|---|---|---|---|---|
| | ML, lbf-inch | T90, min | TS2, min | MH, lbf-inch |
| Ex. 20 | 12.43 | 3.75 | 0.44 | 39.43 |

TABLE 8

| | Durometer Shore A, points |
|---|---|
| Ex. 20 | 92 |

With specific reference to FIG. 4H and as previously described, a head 102 for a mallet 100H may be constructed from the solid rubber composition 100 described herein. The mallet 100H may further include a handle 104. The handle 104 may be operatively connected to the head 102, such as by being at least partially inserted into a portion of the head 102. The handle 104 may be constructed of a high-density polyethylene (HDPE), such as a recycled HDPE (e.g., recycled from milk bottles, HDPE packaging, or the like, including combinations thereof), which may optionally include reinforced glass fibers.

While compositions and methods have been described in connection with the various embodiments of the various figures, it will be appreciated by those skilled in the art that changes could be made to the embodiments without departing from the broad inventive concept thereof. It is understood, therefore, that this disclosure is not limited to the particular embodiments disclosed, and it is intended to cover modifications within the spirit and scope of the present disclosure as defined by the claims.

When a list is presented, unless stated otherwise, it is to be understood that each individual element of that list, and every combination of that list, is a separate embodiment. For example, a list of embodiments presented as “A, B, or C” is to be interpreted as including the embodiments, “A,” “B,” “C,” “A or B,” “A or C,” “B or C,” or “A, B, or C.”

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of this disclosure. As used herein, the term “and/or” includes any and all combinations of one or more of the associated listed items.

The terminology used herein is for the purpose of describing particular aspects only and is not intended to be limiting of this disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

What is claimed is:

1. A foam rubber composition, comprising:
a base recycled vulcanized rubber;
one or more foaming agents; and
one or more processing aids.

2. The foam rubber composition of claim 1, wherein the base recycled vulcanized rubber includes devulcanized rubber, grounded rubber, reclaimed rubber, or combinations thereof.

3. The foam rubber composition of claim 1, wherein the base recycled vulcanized rubber is selected from the group consisting of end-of-life tires, waste ethylene propylene diene monomer (EPDM) rubber parts, end-of-life butyl rubber tubes, used nitrile gloves, used latex gloves, and waste thermoset rubber.

4. The foam rubber composition of claim 1, wherein the one or more foaming agents are powders selected from the group consisting of p-toluenesulfonyl semicarbazide (TSSC), 5-phenyl tetrazole (5-PT), dinitroso pentamethylene tetramine (DPT), carbon monoxide (CO), benzensulfonyl hydrazide (TSH), azodicarbonamide, unexpanded thermoplastic microspheres, and supercritical carbon dioxide.

5. The foam rubber composition of claim 1, wherein the one or more processing aids include a curative, an accelerator, an activator, a fatty acid, a reodorant, a non-recycled elastomer, or combinations thereof.

6. The foam rubber composition of claim 1, wherein the foam rubber composition includes:
from 15 to 175 parts, per hundred of rubber (PHR), of the base recycled vulcanized rubber;
from 3 to 10 parts, per hundred of rubber (PHR), of the one or more foaming agents; and
from 1 to 20 parts, per hundred of rubber (PHR), of the one or more processing aids.

7. The foam rubber composition of claim 1, further comprising a non-recycled elastomer, wherein the foam rubber composition includes from 5 to 95 parts, per hundred of rubber, of the non-recycled elastomer.

8. The foam rubber composition of claim 1, further comprising a curative, wherein the foam rubber composition includes from 0.5 to 5 parts, per hundred of rubber (PHR), of the curative.

9. The foam rubber composition of claim 8, wherein the curative is selected from the group consisting of sulphur, peroxide, Phenolic resins, metal oxide based curatives, or combinations thereof.

10. The foam rubber composition of claim 1, further comprising an accelerator, wherein the foam rubber composition includes from 0.25 to 2.25 parts, per hundred of rubber, of the accelerator.

11. The foam rubber composition of claim 9, wherein the accelerator is selected from the group belonging to amines group, Dithiocarbamates group, Xanthates group, Sulphenamides group, Thiurams group, and Benzothiazoles group.

12. The foam rubber composition of claim 1, further comprising:
an activator, wherein the foam rubber composition includes from 1 to 10 parts, per hundred of rubber (PHR), of the activator; and
a fatty acid, wherein the foam rubber composition includes from 0.25 to 10 parts, per hundred of rubber, of the fatty acid.

13. A product constructed from the foam rubber composition of claim 1, wherein the product is selected from the group consisting of a footwear insole, a footwear outsole, a footwear midsole, a splash block, and a seat cushion.

14. The product of claim 13, wherein the product has a density of from about 100 to about 700 kg/m³ and a shore A hardness of from about 10 to about 70.

15. A method for producing the foam rubber composition of claim 1, the method comprising:
providing the base recycled vulcanized rubber; and
combining the base recycled vulcanized rubber with one or more foaming agents and one or more processing aids.

16. A solid rubber composition, comprising:
a base recycled vulcanized rubber; and
one or more processing aids.

17. The solid rubber composition of claim 16, wherein the one or more processing aids include a curative, an accelerator, an activator, a fatty acid, a reodorant, a non-recycled elastomer, or combinations thereof.

18. The solid rubber composition of claim 16, wherein the solid rubber composition includes:
from 15 to 175 parts, per hundred of rubber (PHR), of the base recycled vulcanized rubber; and
from 1 to 95 parts, per hundred of rubber (PHR), of the one or more processing aids.

19. A product constructed from the solid rubber composition of claim 16, wherein the product is selected from the group consisting of a footwear outsole, a footwear midsole, a mallet head, a caster wheel, a skateboard wheel, a door wedge, a toilet plunger head, and a marine fender.

20. A mallet, comprising:
a head constructed from the solid rubber composition of claim 16; and
a handle made from a recycled high-density polyethylene (HDPE).
